(19) United States
(12) Patent Application Publication
(10) Pub. No.: US 2014/0056177 A1
(43) Pub. Date: Feb. 27, 2014

(54) DIRECTIONAL WIRELESS NETWORK DISCOVERY

(71) Applicants: Jarkko Lauri Sakari Kneckt, Espoo (FI); Eng Hwee Ong, Singapore (SG)

(72) Inventors: Jarkko Lauri Sakari Kneckt, Espoo (FI); Eng Hwee Ong, Singapore (SG)

(73) Assignee: NOKIA CORPORATION, Espoo (FI)

(21) Appl. No.: 13/591,488

(22) Filed: Aug. 22, 2012

(51) Int. Cl. H04W 48/16

(52) U.S. Cl. 370/255

(57) ABSTRACT

A wireless device may perform one or more omnidirectional scans for network wireless devices. Based at least in part on results of those omnidirectional scans, the scanning wireless device may determine that one or more directional scans should be performed. The scanning wireless device may then select one or more scan directions and perform a directional scan in each of those scan directions.

### BACKGROUND

In various existing schemes for wireless communications, one or more wireless communicating devices may form a wireless network with one or more other wirelessly communicating devices. In some cases, a first wireless device may join a wireless network by becoming a part of a pre-existing network already formed by other wireless devices. In other cases, a first wireless device may join a wireless network by creating a wireless network with one or more other wireless devices. In order to join a wireless network, one wireless device must discover another wireless device. Typically, the discovery process involves various omnidirectional “scanning” communications. If a first wireless device cannot find an access point or other wireless device through omnidirectional scanning, the first wireless device may then assume that the scanned channels are idle and no other wireless devices are available for networking

### SUMMARY

This Summary is provided to introduce a selection of concepts in a simplified form that are further described below in the Detailed Description. This Summary is not intended to identify key or essential features of the invention.

Embodiments include, without limitation, methods for directionally scanning for network wireless devices. Embodiments further include, without limitation, devices and/or systems configured to perform such methods. Embodiments additionally include, without limitation, machine-readable media storing instructions that, when executed, cause a device and/or system to perform such methods. Embodiments also include, without limitation, methods for altering a transmission mode of a network wireless device, devices and/or systems configured to perform such methods, and machine-readable media storing instructions that, when executed, cause a device and/or system to perform such methods.

In some embodiments, a scanning wireless device may perform one or more omnidirectional scans for network wireless devices. Based at least in part on results of those omnidirectional scans, the scanning wireless device may determine that one or more directional scans should be performed. The scanning wireless device may then select one or more scan directions and perform a directional scan in each of those scan directions. Each directional scan may include increasing a receiving sensitivity of the scanning wireless device in the selected scan direction relative to a receiving sensitivity of the scanning wireless device in other directions and relative to a receiving sensitivity of the scanning wireless device during the one or more omnidirectional scans. Each directional scan may further include increasing a transmission gain of the scanning wireless device in the selected scan direction relative to a transmission gain of the scanning wireless device in other directions and relative to a transmission gain of the scanning wireless device during the one or more omnidirectional scans.

In some embodiments, a network wireless device may transmit in a first mode. The first mode transmissions may have a first coverage region. The network wireless device may receive data corresponding to a second mode in which transmissions will have a second coverage region different from the first coverage region. At least in part in response to the received data, the network wireless device may begin transmitting in the second mode.

Additional embodiments are disclosed herein.

### BRIEF DESCRIPTION OF THE DRAWINGS

Some embodiments are illustrated by way of example, and not by way of limitation, in the figures of the accompanying drawings and in which like reference numerals refer to similar elements.

FIGS. 1A and 1B are diagrams showing a scanning wireless device and network wireless devices according to some embodiments.

FIGS. 2A and 2B are a flow chart showing operations performed by a scanning wireless device according to some embodiments.

FIGS. 2C and 2D are a flow chart showing operations performed by a scanning wireless device according to some additional embodiments.

FIG. 2E is a flow chart showing operations performed by a scanning wireless device according to at least some embodiments.

FIGS. 3A through 3C are diagrams illustrating determination, according to some embodiments, of scan directions based on motion of a wireless station.

FIG. 4 is a diagram illustrating multiple active directional scans according to some embodiments.

FIGS. 5A through 5D are diagrams illustrating active directional scanning according to some additional embodiments.

FIGS. 6A and 6B are diagrams illustrating operations by a network wireless device according to some embodiments.

FIG. 7 is a flow chart showing operations performed by a network wireless device according to some embodiments.

FIG. 8 is a diagram of an exemplary computer according to some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

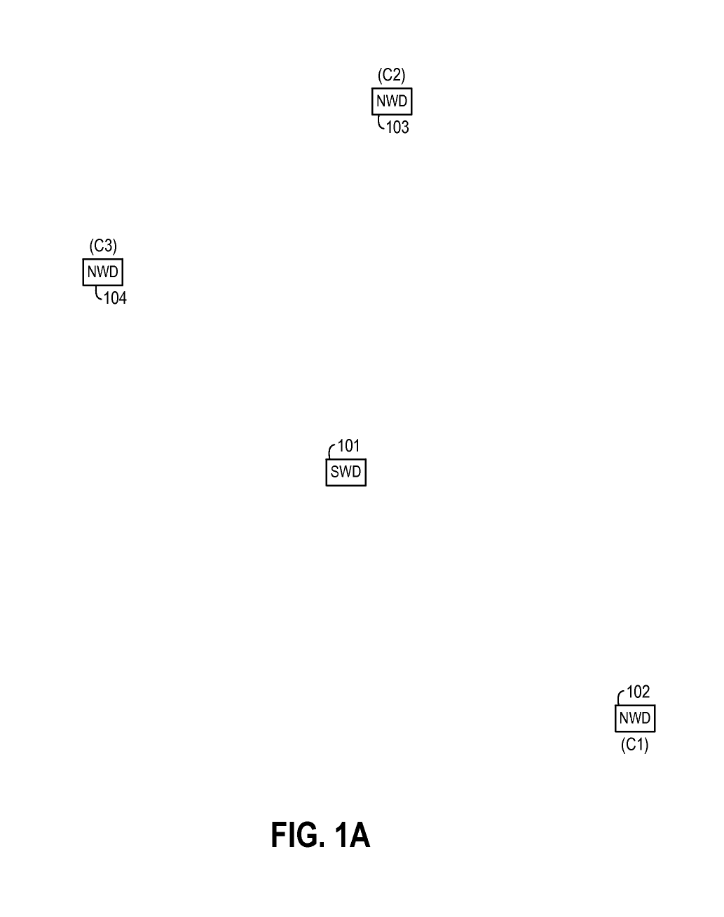

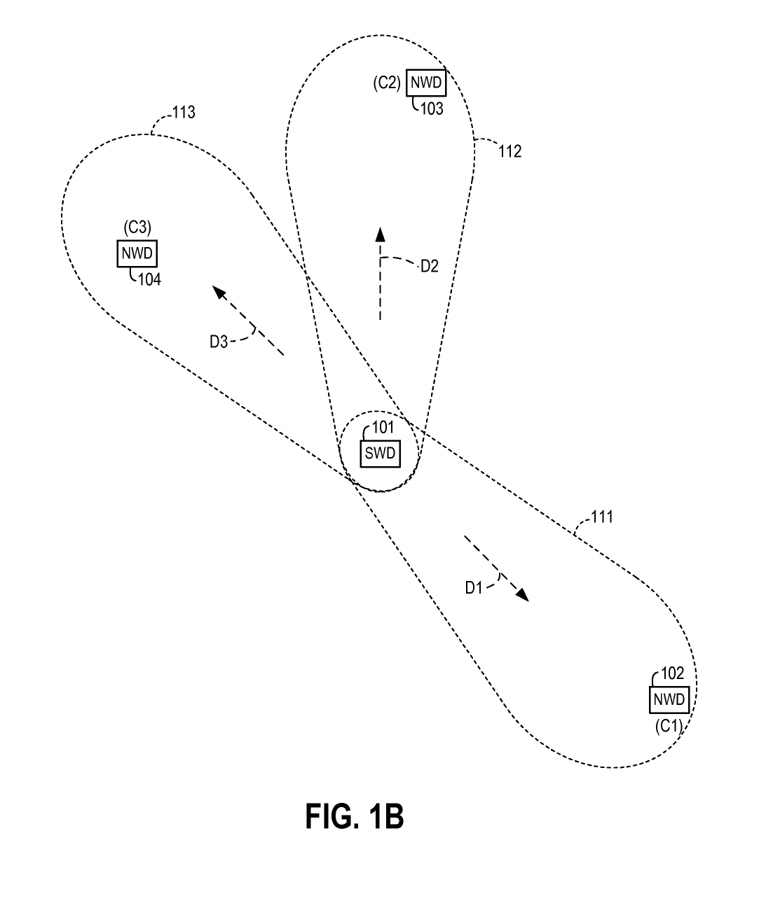

FIG. 1A is a diagram showing a scanning wireless device 101 and network wireless devices 102-104 according to some embodiments. As used herein, a “scanning wireless device” or “SWD” is a wirelessly communicating device capable of joining a wireless network that includes one or more other wirelessly communicating devices and which discovers such other wirelessly communicating devices by scanning. As described below, such scanning may be active or passive. As also used herein, a “network wireless device” or “NWD” is a wirelessly communicating device with which an SWD may link to join a wireless network and which an SWD may identify through a scanning process. Depending on the topology and applicable protocols being used, an NWD in some embodiments may not actually be part of a network until creation of that network with an SWD.

In some embodiments, an NWD may be an access point configured to form a wireless network with one or more wireless stations. In some embodiments, for example, the network may have an infrastructure topology in which wireless stations communicate with an access point to exchange data with each other and/or with elements in additional networks (e.g., the Internet) with which the access point is also in communication. In the example of FIG. 1A, SWD 101 could be a wireless station and NWDs 102-104 could be access points, with SWD 101 configured to establish a wireless link and communicate with a network through one or more of NWDs 102-104. SWD 101 and the NWD(s) with which SWD 101 may communicate may operate in one or more of various portions of the RF spectrum and in accordance with various different protocols. For example, SWD 101 may be configured to communicate in the 2.4 GHz, 3.6 GHz or 5 GHz “WiFi” bands in accordance with one or more portions of Institute of Electrical and Electronics Engineers standard 802.11-2012 (IEEE 802.11-2012) and/or other standards. As another example, SWD 101 might also (or alternatively) be configured to communicate in unused frequencies in the TV band spectrum known as TV white spaces (TVWS) according to IEEE 802.11-2012 and/or other standards (e.g., IEEE P802.11af). SWD 101 might also or alternatively be configured to communicate in other frequency bands and/or according to other standards or protocols.

According to some embodiments, an SWD may be at least one of a station (STA) and a non-access point station (non-AP STA) and an NWD may be an access point (AP).

An SWD may join a wireless network with one or more NWDs so as to form a network having any of various different topologies. Such topologically different networks could include infrastructure topologies such as that described above, IBSS (independent basic service set) wireless networks, mesh wireless networks and ad hoc wireless networks. In an IBSS network, wireless local area network stations share a common beacon transmission procedure. A station that transmits a beacon will remain active for a beacon period and respond to scanning requests. A mesh BSS (basic service set) may include equal mesh stations that all transmit beacon signals and that respond to scanning requests. Mesh stations may implement frame forwarding so as to expand coverage of a mesh network. An ad hoc network may allow wireless devices that are within range of on another other to discover and communicate in a peer-to-peer manner and without using a designated access point. In these and other topologies, a device may act as both an SWD and as an NWD, either simultaneously or in the alternative.

In some embodiments, an SWD and one or more NWDs may be (or become) part of a Wi-Fi Direct network. In such a network, one NWD is an “owner” that is similar to an access point with reduced functionality. An owner may respond to scanning requests on behalf of its Wi-Fi Direct BSS. Other types of wireless networks in which various embodiments can be employed include, without limitation, femto networks, LTE (long term evolution) networks, etc.

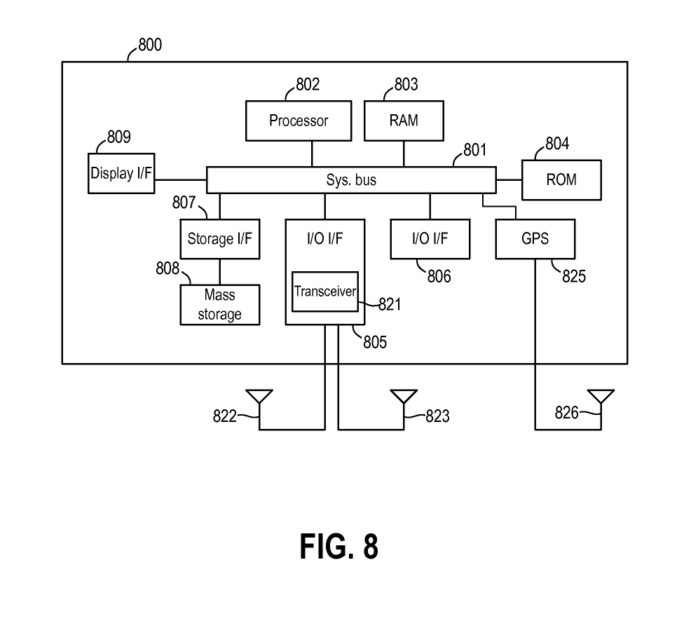

SWD 101 may be a laptop computer, a tablet computer, a smart phone, or other type of mobile device. Exemplary hardware for SWD 101 is described in connection with FIG. 8. SWD 101 is able to communicate omnidirectionally and directionally. During omnidirectional communications, SWD 101 does not attempt to concentrate transmission gain or reception sensitivity in a particular direction. During directional communications, SWD 101 concentrates transmission gain and/or reception sensitivity in a chosen or “steered” direction. In particular, SWD 101 is configured to steers its antenna(s) and/or other transceiver components so that receiving sensitivity and/or transmission gain is higher in the steered direction(s) than in other directions. SWD 101 may include multiple antennas to implement such steering. Numerous techniques and hardware systems for steering RF transmission and/or reception sensitivity are well known and thus not further described herein.

SWD 101 is also able to communicate on multiple channels. As used herein, “channel” generically refers to a subportion of available communication capacity within a frequency band. A channel may be a continuous sub-portion of a frequency band, may be a collection of non-continuous frequencies or sub-bands (e.g., a subgroup of available orthogonal frequency division multiplexing subcarriers), may be one of several code division multiplexing codes, etc. In some embodiments, available channels may be defined by a communication protocol used by an SWD and one or more NWDs.

As indicated above, SWD 101 communicates with one or more NWDs by establishing a link with at least one NWD. After establishing such a link, SWD 101 may communicate through that NWD with other devices in the same wireless network. Such devices may include other stations that have also established a link with that same NWD. SWD 101 may communicate, through that NWD, with devices in the Internet or other networks with which that NWD may be connected. In order to establish a link with an NWD, SWD 101 must search for and identify one or more candidate NWDs. Searching for an NWD, also known as “scanning,” may be passive or active. In passive scanning, SWD 101 simply listens for (i.e., determines if it is receiving) a beacon communication or other type of transmission from an NWD. Such transmissions may also include data describing supported protocols and/or other communication parameters that SWD 101 and/or other wireless devices may use to establish a link with a transmitting NWD.

In active scanning, SWD 101 transmits a request communication seeking a response from candidate NWDs. Such a request communication may include data identifying SWD 101 as an authorized device and/or other data regarding SWD 101. The request may also include data that specifies certain criteria for candidate NWDs. For example, SWD 101 may be seeking to establish a link with an NWD operated by a particular network provider and/or an NWD that conforms to certain communication parameters. In some embodiments, only NWDs able to satisfy specified criteria respond to a request from an SWD.

Various types of passive and active scanning are well known and described in IEEE 802.11-2012 and other standards. In at least some embodiments, known passive and active scanning communication protocols can be used by an SWD and by scanned NWDs in connection with inventive scanning procedures described herein. For convenience, an active scan communication from an SWD seeking a response from candidate NWDs will be referred to generically as a “scan request.” A response to a scan request from an NWD will be referred to generically as a “scan response.”

According to some embodiments, a request may comprise a probe and/or GAS (generic advertisement service) request and a response may comprise a probe and/or GAS response. Procedures for exchanging probe request and probe response messages may be based on one or more 802.11 standards.

Each of NWDs 102-104 in FIG. 1A communicates in the same band and according to the same communication protocol as SWD 101. In the example of FIG. 1A, NWDs 102-104 are currently communicating omnidirectionally on channels C1, C2 and C3 respectively. As described in further detail below, some NWDs may be able to communicate both omnidirectionally and directionally. SWD 101 is also operating in an omnidirectional mode in FIG. 1A. While SWD 101 is operating in an omnidirectional mode, the reception sensitivity of the SWD 101 transceiver is not sufficiently high to allow communications with NWDs 102-104. The SWD 101 transceiver may be unable to detect signals from NWDs 102-104, or may only detect those signals intermittently and/or decode with an unacceptable error rate. Similarly, the transmission gain of the SWD 101 transceiver is too low to permit transceivers of NWDs 102-104 to detect and decode signals from SWD 101 at a sufficiently low error rate.

FIG. 1B shows expanded communication regions when SWD 101 operates in a directional mode. When SWD 101 configures its transceiver for a directional communication in a first direction D1, SWD 101 has a transmission gain and reception sensitivity in expanded communication region 111 that are greater than the transmission gain and reception sensitivity of that transceiver in regions associated with other directions. The transmission gain of the SWD 101 transceiver in region 111 is greater than the transmission gain of that transceiver when SWD 101 operates at the same transmit power level in omnidirectional mode. The reception sensitivity of the SWD 101 transceiver in region 111 is greater than the reception sensitivity of the transceiver when SWD 101 operates in omnidirectional mode.

When operating in directional mode, SWD 101 is thus able to communicate with NWDs in region 111 that are more distantly located, and with which SWD 101 might not be able to communicate when operating in omnidirectional mode. In particular, the increased transmission gain in region 111 allows more distantly located NWDs within region 111 to detect communications from SWD 101 at a sufficiently low error rate. The increased reception sensitivity in region 111 allows SWD 101 to detect weaker signals from more distantly located NWDs within region 111 and to decode such signals with a sufficiently low error rate.

In a similar manner, SWD 101 can configure its transceiver for directional transmissions in other directions. When SWD 101 configures its transceiver for a directional communication in a second direction D2 or in third direction D3, SWD 101 has a transmission gain and reception sensitivity in expanded communication regions 112 and 113, respectively, that are greater than the transmission gain and reception sensitivity of that transceiver in regions associated with other directions, and which are also greater than the transmission gain (at the same transmit power level) and reception sensitivity of that transceiver when SWD 101 operates in omnidirectional mode. Although FIG. 1B only shows expanded communication regions associated with three directions, SWD 101 could configure its transceiver for directional communication in other directions.

For convenience, expanded communication regions D1, D2 and D3 are represented as simple bulbous shapes. The actual shapes of expanded communication regions may not be as shown in FIG. 1B or in other drawing figures. Shapes of expanded communication regions associated with specific directions may not be identical for every direction and may vary based on various factors. Those factors could include atmospheric conditions, surrounding structures, hardware idiosyncrasies, etc. Moreover, a region of increased transmission gain for a particular direction may not necessarily have the same shape as the region of increased reception sensitivity. FIG. 1B only shows directional transmission ranges based on two dimensions. In particular, FIG. 1B assumes that SWD 101 only steers directional communications in the horizontal plane of the figure. In at least some embodiments, and as described below, directional communications may be steered in three dimensions.

As shown in FIG. 1B, SWD 101 is able to communicate with NWD 102 on channel C1 when the SWD 101 transceiver is configured for communication in direction D1. SWD 101 is able to communicate with NWD 103 on channel C2 when the SWD 101 transceiver is configured for communication in direction D2. SWD 101 is able to communicate with NWD 104 on channel C3 when the SWD 101 transceiver is configured for communication in direction D3. In some embodiments, and as described below, an SWD may scan multiple channels and multiple directions when attempting to discover an NWD.

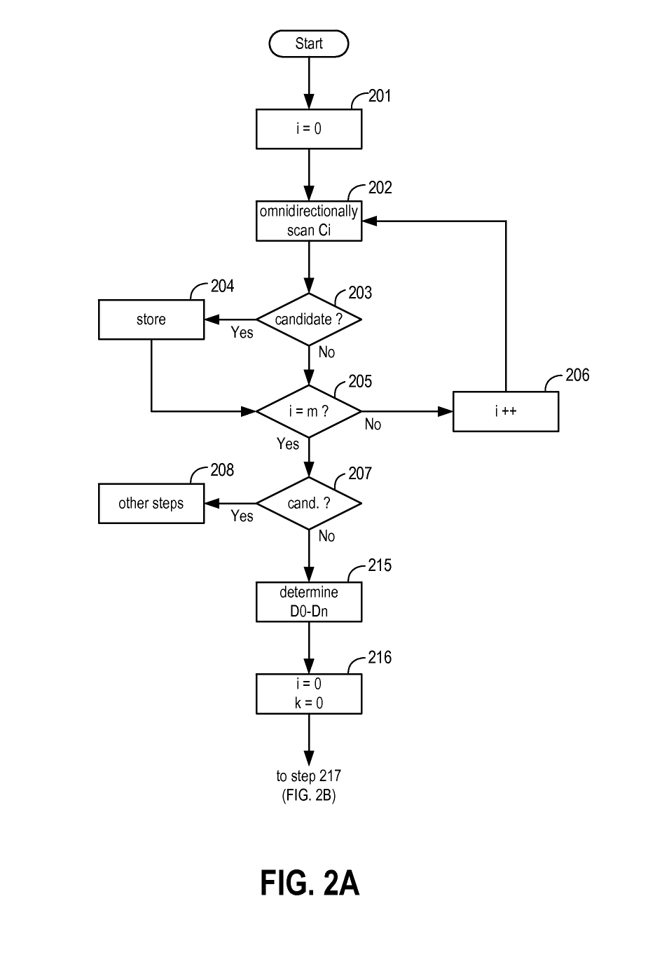

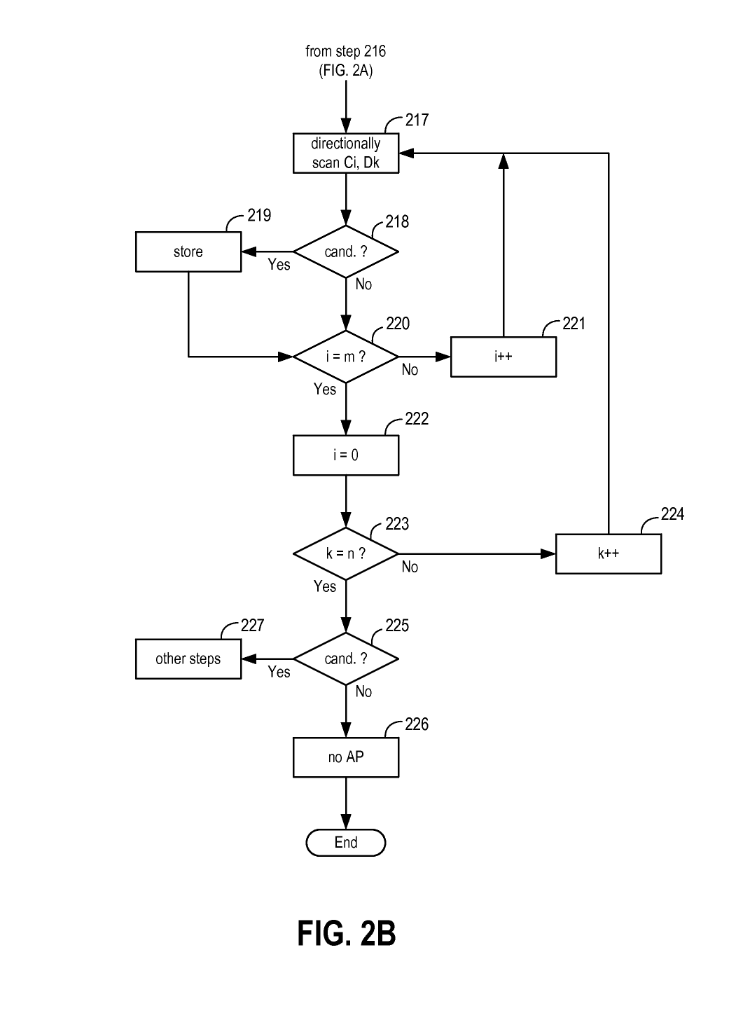

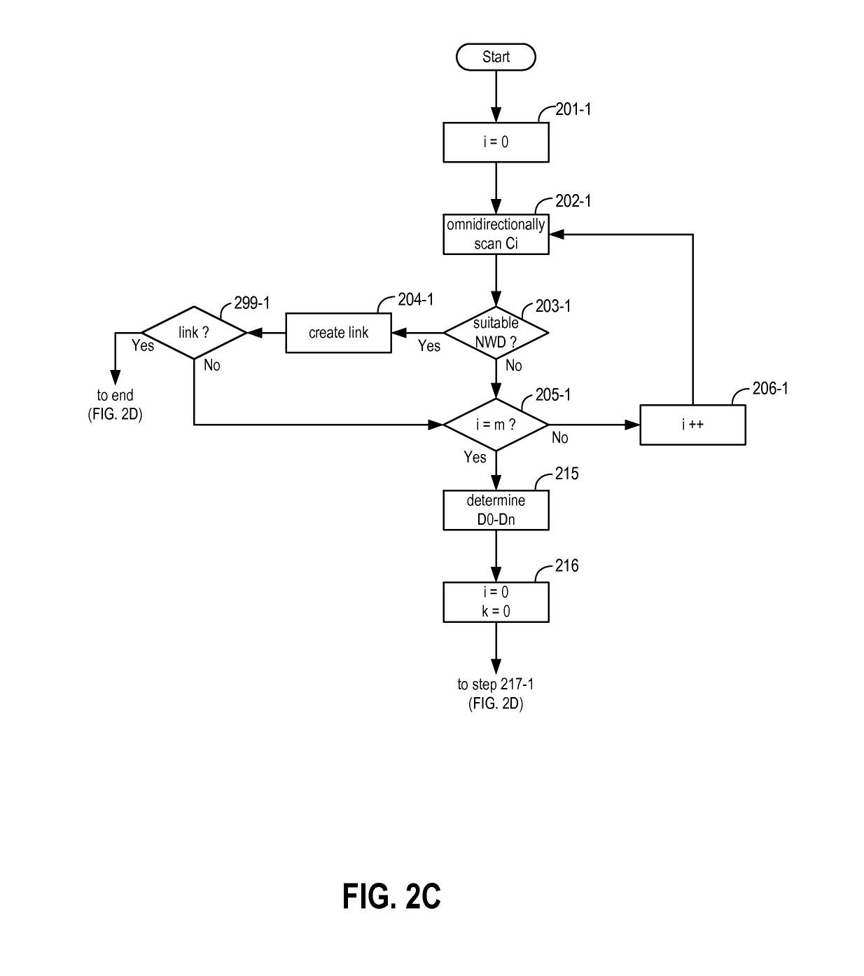

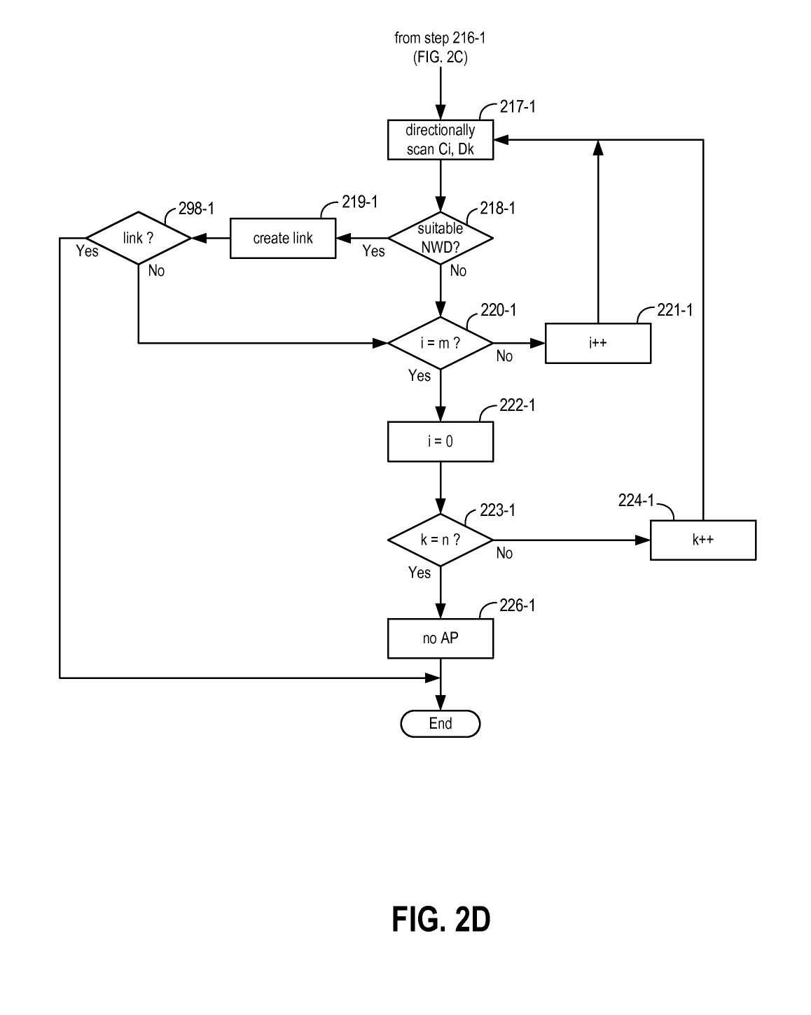

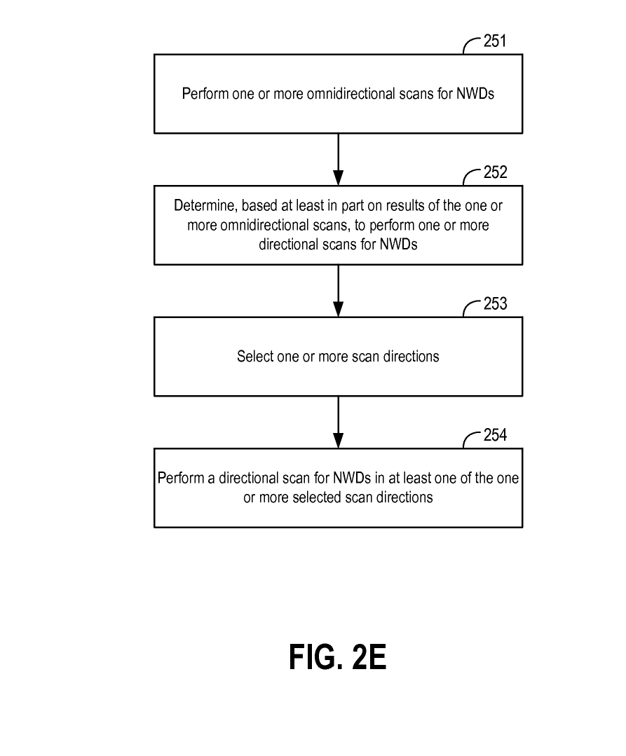

FIGS. 2A and 2B are a flow chart showing operations performed by SWD 101, according to some embodiments, when scanning for NWDs. FIGS. 2A and 2B merely represent certain embodiments. In other embodiments, one or more steps indicated in FIGS. 2A and 2B may be omitted, rearranged or replaced with different steps. Other steps might also or alternatively be added. Examples of some of these other embodiments are described in further detail below. The steps indicated in FIGS. 2A and 2B may be performed by a processor, an application specific integrated circuit (ASIC) and/or other hardware within SWD 101. For convenience, performance of operations by such hardware will be generically described as performance of operations by SWD 101. Such operations may be performed as the result of executing machine-executable instructions stored within one or more memories of SWD 101 and/or executing instructions that are stored as hard-coded dedicated logic.

SWD 101 is configured to communicate on any of multiple channels 0 through m, where “m” is an arbitrary integer. Those channels may be defined by an applicable communication protocol, by policies implemented by networks in which SWD 101 is authorized to communicate, and/or in some other manner. In step 201, SWD 101 initializes a counter i to zero. SWD 101 scans channel i (Ci), in an omnidirectional mode, at step 202. The scan may be passive or may be active. At step 203, SWD 101 determines if a candidate NWD was detected in the just-completed scan. If so, SWD 101 proceeds to step 204 on the “yes” branch and stores data received from or otherwise deduced for that detected candidate NWD. Such data could include identifier data (e.g., a basic service set identifier (BSSID)), the channel Ci on which the candidate NWD was detected, the strength of the signal from the candidate NWD (e.g., the received signal strength indicator (RSSI)), communication parameters for establishing a link with the candidate NWD, etc. From step 204, SWD 101 then proceeds to step 205. If at step 203 SWD 101 determines that a candidate NWD was not detected in the just-completed scan, SWD 101 proceeds to step 205 on the “no” branch from step 203.

At step 205, SWD 101 determines if the current value of the i counter equals m. If not, SWD 101 proceeds on the “no” branch to step 206, where the i counter is incremented by 1. SWD 101 then returns to step 202 and performs a new omnidirectional scan on channel Ci. In this manner, steps 202, 203, 205 and 206 are repeated until all of channels 0 through m have been omnidirectionally scanned. Depending on the outcome of each omnidirectional scan, step 204 may be performed in connection with some, all or none of those omnidirectional scans.

When all of channels 0 through m have been omnidirectionally scanned, i=m, and SWD 101 proceeds on the “yes” branch from step 205 to step 207. At step 207, SWD 101 determines if any candidate NWDs were identified (i.e., if step 204 was performed). If so, SWD 101 terminates scanning and proceeds to further steps 208. In steps 208, SWD 101 selects an NWD. If only one candidate NWD was detected, that candidate is selected. If multiple candidate NWDs were detected, SWD 101 may select an NWD based on signal strength, based on a network provider or other entity associated with an NWD and/or based on other factors. After selecting an NWD, SWD 101 performs additional steps 208 to establish a communication link with that NWD.

If SWD 101 determines at step 207 that no candidate NWDs were detected as a result of omnidirectional scanning, SWD 101 continues to step 215. SWD 101 then determines scan directions 0 through n that will be directionally scanned for candidate NWDs, where “n” is an arbitrary integer. In some embodiments, SWD 101 may determine scan directions by accessing a previously stored list of directions. One example of such a list is included as Table 1.

TABLE 1
Example Scan Direction Table

| index | scan direction |
|---|---|
| 0 | Horizontal (0° elevation), 0° azimuth from reference direction |
| 1 | Horizontal (0° elevation), 180° azimuth from reference direction |
| 2 | Horizontal (0° elevation), 270° azimuth from reference direction |
| 3 | Horizontal (0° elevation), 90° azimuth from reference direction |
| 4 | Upward (90° up elevation) |
| 5 | Downward (90° down elevation) |
| 6 | Horizontal (0° elevation), 315° azimuth from reference direction |
| 7 | Horizontal (0° elevation), 135° azimuth from reference direction |
| 8 | Horizontal (0° elevation), 45° azimuth from reference direction |
| 9 | Horizontal (0° elevation), 225° azimuth from reference direction |
| 10 | Upward (45° up elevation), 315° azimuth from reference direction |
| 11 | Upward (45° up elevation), 135° azimuth from reference direction |
| 12 | Upward (45° up elevation), 45° azimuth from reference direction |
| 13 | Upward (45° up elevation), 225° azimuth from reference direction |
| 14 | Downward (45° down elevation), 315° azimuth from reference |
| | direction |
| 15 | Downward (45° down elevation), 135° azimuth from reference |
| | direction |
| 16 | Downward (45° down elevation), 45° azimuth from reference |
| | direction |
| 17 | Downward (45° down elevation), 225° azimuth from reference |
| | direction |

Directions 0-3 and 6-9 in Table 1 are in the horizontal plane. Directions 4 and 5 are straight up and straight down, respectively, and orthogonal to the horizontal plane of directions 0-3 and 6-9. Directions 10-13 are angled upward from the horizontal plane. Directions 14-17 are angled downward from the horizontal plane. For all directions having a horizontal component, Table 1 specifies an azimuth relative to a “reference direction.” That reference direction could be defined in any of various manners. The reference direction could be arbitrarily chosen as a direction in which a predefined portion of SWD 101 is pointing. For example, the reference direction might be defined as the direction in which the front of SWD 101 is pointing. If SWD 101 includes a compass, the reference direction could be defined as a particular compass heading (e.g., due north). The example of Table 1 assumes that SWD 101 includes a clinometer, tilt sensor or other hardware that permits SWD 101 to determine its orientation with respect to the horizontal. However, this need not be the case. In some embodiments, SWD 101 might be configured to assume that it is in a particular orientation when performing directional scans. If SWD 101 is a laptop computer, for instance, SWD 101 may assume that the keyboard portion of SWD 101 is horizontal when directionally scanning SWD 101 could also be configured to display a message to a user instructing the user to place SWD 101 into a particular orientation when directional scanning begins.

Table 1 is merely one example of a scan direction table. The ordering and/or definitions of directions could be varied, additional or fewer directions included, etc. Numerous other scan direction tables could be created. SWD 101 might include multiple scan direction tables in some embodiments. In some such embodiments, for example, a first table may be similar to Table 1, and a second table may have fewer entries (e.g., only entries for horizontal scans). SWD 101 could then could then be configured to use one of those tables in step 215 based on a user selection or other configuration (e.g., choose the second table if SWD 101 is in a power-saving mode).

In some embodiments, and as described in further detail below, SWD 101 may determine scan directions based on a current motion vector of SWD 101. In certain of those embodiments, SWD 101 could be configured to first determine if SWD 101 is stationary or in motion. If stationary, Table 1 (or other previously stored scan direction table) could be used. If in motion, scan directions could be selected based on the motion vector.

In step 216, SWD 101 initializes counters i and k by setting each equal to zero. As with the omnidirectional scanning of steps 202 through 206, counter i will be used to track scanned channels. Counter k will be used to track scan directions.

SWD 101 proceeds from step 216 to step 217 (FIG. 2B). At step 217, SWD 101 performs a directional mode scan of channel i (Ci) in direction k (Dk). The scanning may be passive or active. If the directional scan is passive, SWD 101 configures its transceiver to increase reception sensitivity in the scan direction. If the scan is active, SWD 101 configures its transceiver to increase gain in the scan direction. For active scanning, SWD 101 might also configure its transceiver to increase reception sensitivity in the scan direction.

SWD 101 then proceeds to step 218 and determines if a candidate NWD was detected in the just completed directional scan. If so, SWD 101 proceeds to step 219 on the “yes” branch and stores data for the detected candidate NWD. Such data can include data of the type(s) described in connection with step 204, as well as the scan direction Dk when the NWD was detected. From step 219, SWD 101 proceeds to step 220. If SWD 101 determines in step 218 that a candidate NWD was not detected in the just completed directional scan, SWD 101 proceeds to step 220 on the “no” branch from step 218.

At step 220, SWD 101 determines if all channels have been scanned in the current scan direction Dk (i.e., if i=m). If not, SWD 101 proceeds to step 221 on the “no” branch. The i counter is incremented by 1 in step 221, after which SWD 101 returns to step 217 and performs a new directional scan. If SWD 101 determines in step 220 that all channels have been scanned, SWD 101 proceeds to step 222 on the “yes” branch and resets counter i to zero. SWD 101 then continues to step 223 and determines if all n scan directions determined in step 215 have been scanned (i.e., if k=n). If not, SWD 101 proceeds to step 224 on the “no” branch. After incrementing counter k by 1 at step 224, SWD 101 returns to step 217.

If SWD 101 determines in step 223 that all scan directions have been scanned (i.e., k=n), SWD 101 proceeds to step 225 on the “yes” branch. At step 225 SWD 101 determines if any candidate NWDs were detected during the directional scans. If so, SWD 101 proceeds to steps 227. In steps 227, SWD 101 selects an NWD. If only one candidate NWD was detected, that candidate is selected. If multiple candidate NWDs were detected, SWD 101 may select an NWD based on signal strength, based on a network provider or other entity associated with an NWD and/or based on other factors. After selecting an NWD, SWD 101 performs other steps 227 to establish a communication link with that NWD. When establishing that link, SWD 101 configures its transceiver to operate in directional mode so that transmission gain is increased in the direction corresponding to the selected NWD. SWD 101 might also configure its transceiver to increase reception sensitivity in the direction corresponding to the selected NWD. In at least some embodiments, reception sensitivity is lower bounded by a minimum receiver sensitivity parameter and typically relates to the modulation and coding scheme in use.

If no candidate NWDs were detected during the directional scans, SWD 101 proceeds to step 226 on the “no” branch from step 225 and outputs data indicating that no NWD could be found. As part of step 226, SWD 101 may generate a message to a user on a display screen indicating no NWDs are available.

In some embodiments, SWD 101 may terminate a scanning procedure on identifying a suitable access point through omnidirectional or directional scanning FIGS. 2C and 2D are a flow chart showing operations performed by SWD 101 according to some such embodiments. Steps 201-1, 202-1, 205-1, 206-1, 215-1, 216-1, 217-1, 220-1, 221-1, 222-1, 223-1, 224-1 and 226-1 of FIGS. 2C and 2D are substantially similar to steps 201, 202, 205, 206, 215, 216, 217, 220, 221, 222, 223, 224 and 226, respectively, of FIGS. 2A and 2B. In step 203-1 of FIG. 2C, SWD 101 determines if a suitable NWD was identified in the just-completed omnidirectional scan. If not, SWD 101 proceeds to step 205-1 on the “no” branch.” If so, SWD 101 proceeds to step 204-1 on the “yes branch. In step 204-1, SWD 101 attempts to establish a communication link with that identified NWD. In step 299-1, SWD 101 evaluates whether a communication link was successfully established with the identified NWD. If so, the procedure of FIGS. 2C and 2D ends (“yes” branch from step 299-1). Otherwise, SWD 101 proceeds on the “no” branch to step 205-1.

In step 218-1 of FIG. 2D, SWD 101 determines if a suitable NWD was identified in the just-completed directional scan. If not, SWD 101 proceeds to step 220-1 on the “no” branch.” If so, SWD 101 proceeds to step 219-1 on the “yes branch. In step 219-1, SWD 101 attempts to establish a communication link with that identified NWD. In step 298-1, SWD 101 evaluates whether a communication link was successfully established with that identified NWD. If so, the procedure of FIGS. 2C and 2D ends (“yes” branch from step 298-1). Otherwise, SWD 101 proceeds on the “no” branch to step 220-1 and resumes scanning.

As indicated above, one or more steps indicated in FIGS. 2A and 2B may be omitted, rearranged or replaced with other steps, or steps may be otherwise added. FIGS. 2C and 2D are one example of such omission, rearrangement, replacement and/or addition. Another example is shown in FIG. 2E. In step 251, an SWD performs one or more omnidirectional scans for NWDs. In step 252, the SWD determines, based at least in part on results of the one or more omnidirectional scans, to perform one or more directional scans for NWDs. In step 253, the SWD selects one or more scan directions. In step 254, the SWD performs a directional scan for NWDs in at least one of the one or more selected scan directions.

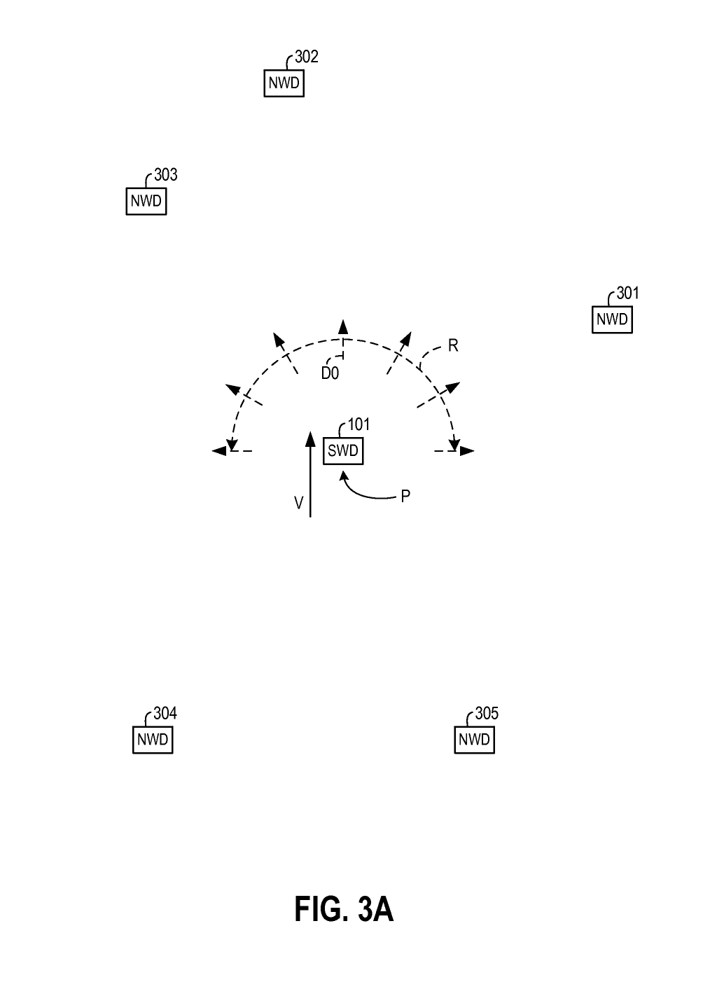

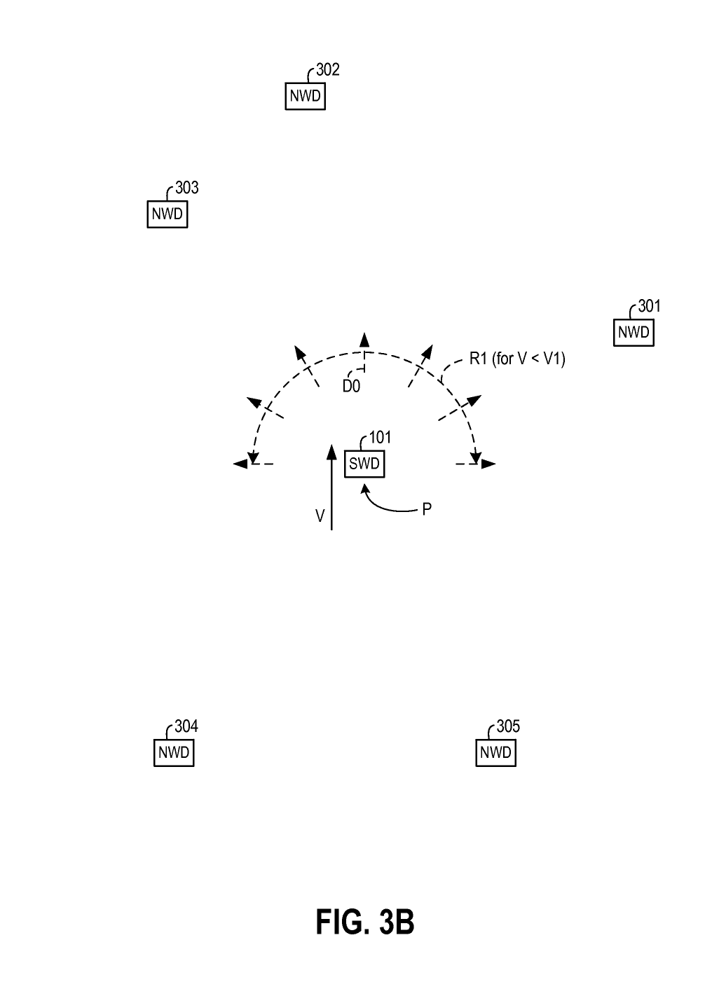

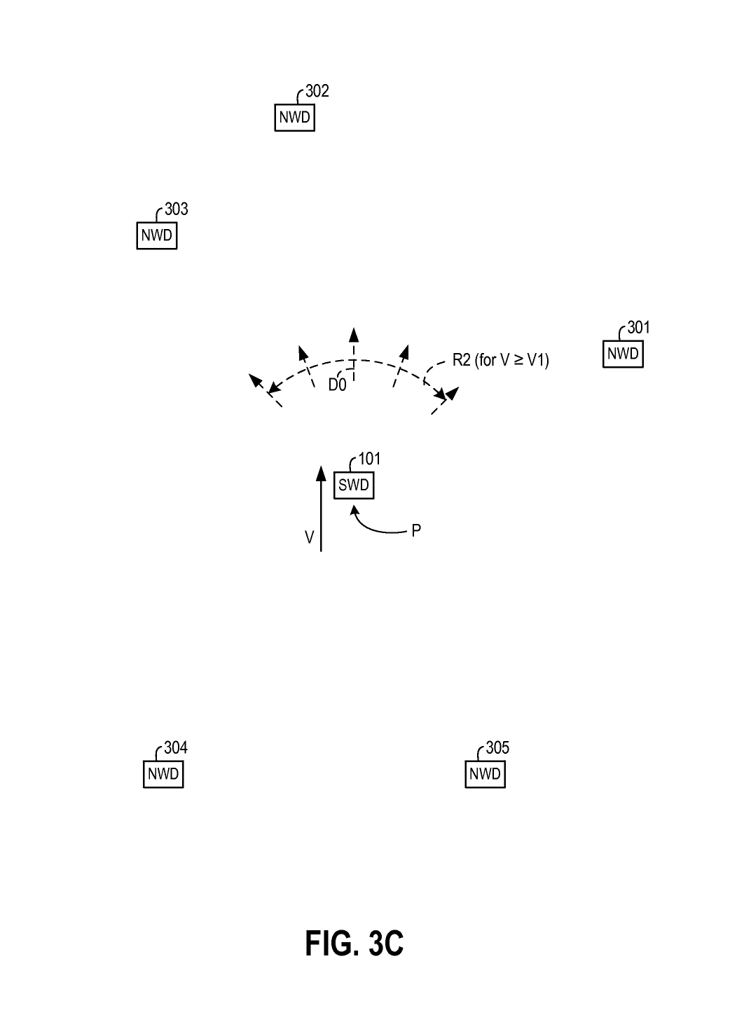

As indicated above, in some embodiments SWD 101 may determine scan directions based on the motion of SWD 101. One such embodiment can be explained in connection with FIG. 3A. In the example of FIG. 3A, SWD 101 is located at position P and is moving in a direction D0 at a velocity of V. SWD 101 is unable to detect an NWD after scanning omnidirectionally from position P, but would be able to detect any of NWDs 301-305 from position P using directional scans in directions corresponding to those NWDs. However, SWD 101 is moving away from NWDs 304 and 305. Thus, even if SWD 101 establishes a link with one of those NWDs while in directional mode, the link might soon be lost because the NWD will be out of range. Accordingly, SWD 101 only performs directional scans within a scan range R that corresponds to the direction of the SWD 101 motion vector and that encompasses less than all azimuth directions. Range R could be, e.g., a 180° range of directions centered on direction D0. After scanning appropriate directions in range R, SWD 101 will detect NWDs 301, 302 and 303.

In some additional embodiments, and as shown in FIGS. 3B and 3C, scan directions are determined based on the direction of the SWD 101 motion and the velocity V of SWD 101. If velocity V is below a threshold V1, and as shown in FIG. 3B, SWD 101 performs directional scans within a scan range R1 (e.g., a 180° range of directions centered on direction D0). If velocity V is at or above V1, and as shown in FIG. 3C, SWD 101 may only perform scanning within a reduced scan range R2 (e.g., a 90° range of directions centered on direction D0). Additional velocity thresholds having corresponding scan ranges could also be included. For example, SWD 101 could be configured to employ a first range R1 for velocities below V1, a second range R2 for velocities below V2, a third range R3 for velocities below V3, etc., with V1<V2<V3 and R3<R2<R1. Threshold values V1, V2, etc. could be set based on average distance between NWDs, could be user-configurable, and/or could be set in some other manner. Scan range values could also be user-configurable.

In some embodiments, SWD 101 may detect NWDs during an omnidirectional scan, but those NWDs may be unsuitable. For example, those NWDs might be operated by a network provider with whom the operator of SWD 101 has no agreement for service, and/or who may charge a fee for access. As another example, those NWDs may be employing protocols or communication parameters that SWD 101 does not support. In some such embodiments, SWD 101 also stores data in step 204 that indicates a direction of a detected NWD relative to SWD 101. SWD 101 may obtain this data by performing angle of arrival measurements in which multiple antennas receive an NWD signal (e.g., a preamble synchronization sequence) and measure the difference in arrival times.

Steps in FIGS. 2A and 2B could be modified to use this stored data regarding unsuitable NWDs to further narrow the directional scans. For example, step 207 could include determining whether an acceptable NWD was found. If not, at step 215 SWD 101 could parse data stored in step 204 for unacceptable NWDs and flag the directions in which those NWDs are located. These flagged directions could then be excluded when determining scan directions in step 215.

In some embodiments, when scanning omnidirectionally, SWD 101 may detect a signal that is too weak to fully process, but that may be consistent with an NWD (e.g., because it is on a channel potentially used by NWDs). In some of these embodiments, SWD 101 also stores data in step 204 that indicates directions of such weak signals. The process of FIGS. 2A and 2B could be modified so that step 215 includes parsing data stored during step for directions associated with faint signals. Those directions could then be prioritized for directional scans.

When performing directional scanning in some embodiments, SWD 101 may configure its transceiver to increase transmission gain in a scan direction without changing reception sensitivity. For example, NWDs may transmit with greater power than wireless stations such as SWD 101, and SWD 101 may be able to detect an NWD once it responds to a scan request. As another alternative or additionally, SWD 101 may steer its transmissions more than its reception. For example, SWD 101 could configure its transceiver to substantially increase transmission gain in a relatively narrow band centered on a scan direction. However, SWD 101 could configure its transceiver to only modestly increase reception sensitivity in a wider band centered on the scan direction.

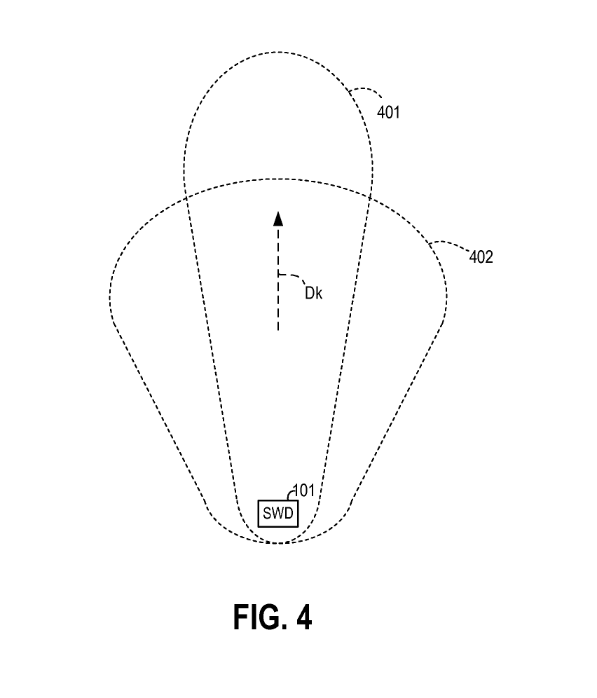

When performing active directional scanning in some embodiments, SWD 101 might send several scan request communications for each channel/direction combination. However, SWD 101 may vary the beam width and power for each scan request. This is illustrated in FIG. 4. Upon commencing directional scans for a particular channel and direction combination Ci and Dk (i.e., on beginning an iteration of step 217), SWD 101 may configure its transceiver to have maximum transmission gain in direction Dk. Using that configuration, SWD 401 then sends a request communication in a region 401. However, increasing transmission gain results in a relatively narrow beam width. Accordingly, SWD 101 may then configure its transceiver to have slightly less transmission gain and retransmit the request communication in a region 402 having a wider beam width. Additional scan communications could be transmitted using less transmission gain so as to achieve wider beam width.

In some embodiments, SWD 101 may first perform active omnidirectional scanning by including response criteria in transmitted scan request communications. For example, SWD 101 may include data in the initial omnidirectional scan requests that indicates only NWDs operated by a particular entity should respond. If none of those omnidirectional scans detects a suitable candidate NWD, additional omnidirectional scans using less restrictive criteria could be transmitted. The less restrictive criteria may allow more NWDs (or any NWD) to respond. If the less restrictive omnidirectional scans also fail to detect a suitable candidate NWD, directional scans could be performed. The directional scans may include the same response criteria as was included in one of the omnidirectional scans, might include less restrictive criteria, or may include no limitations on NWDs that should respond. In some embodiments, the second series of omnidirectional scans with less restrictive criteria might be omitted.

In some embodiments, SWD 101 may cause a display screen to generate images showing the progress of the omnidirectional and/or directional scans. The images could include, e.g., indications of relative bearings and/or distances of detected NWDs relative to SWD 101. SWD 101 may be further configured so that a user may select one of the detected NWDs based on the image, in response to which the scanning process may terminate and SWD 101 could establish a communication link with the selected NWD. In certain embodiments, SWD 101 may cause a display screen to generate an image indicating the relative bearing and/or distance of a selected NWD (whether selected by the user or automatically by SWD 101) so that, e.g., the user can move SWD 101 closer to the selected NWD.

In the example of FIGS. 2A and 2B, SWD 101 performs directional scans in each of multiple scan directions for a given channel before scanning in a new channel. This need not be the case, however. In some embodiments, SWD 101 might perform directional scans in a particular direction for each of multiple channels before changing to a different scan direction. In other words, the nesting of the i and k loops in steps 217 through 224 of FIG. 2B could be reversed.

In some embodiments, a scan response may include parameters of the NWD transmitting the scan response and of other NWDs. After receiving such a scan response, SWD 101 might adjust its scanning order to prioritize NWDs identified in the scan response. For example, assume SWD 101 was implementing the scanning procedure of FIGS. 2C and 2D. Further assume that SWD 101 receives a scan response from an NWD x in step 217-1, which scan response further identifies NWD y and NWD z. In step 219-1, SWD 101 could then try to create a link with NWD x, and if that fails, to then attempt to create a link with NWD y and/or NWD z. Step 298-1 would then include determining whether a link was successfully created with any of NWD x, NWD y or NWD z, with SWD 101 returning to step 220-1 if a link could not be created with any of those NWDs.

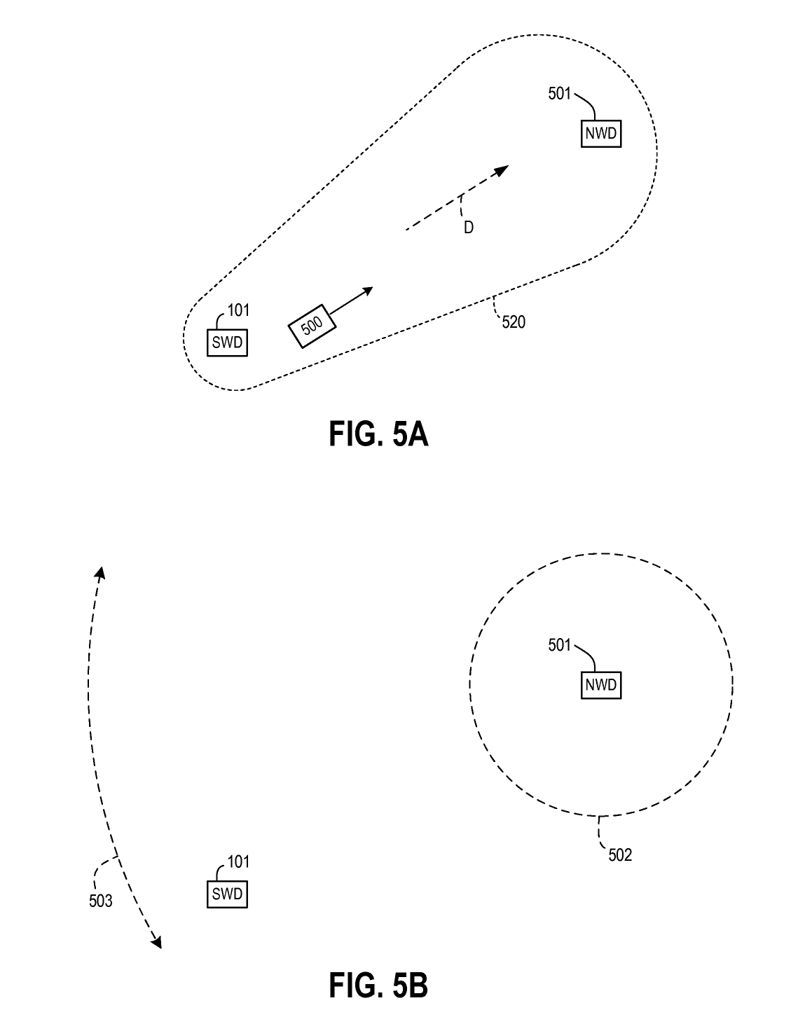

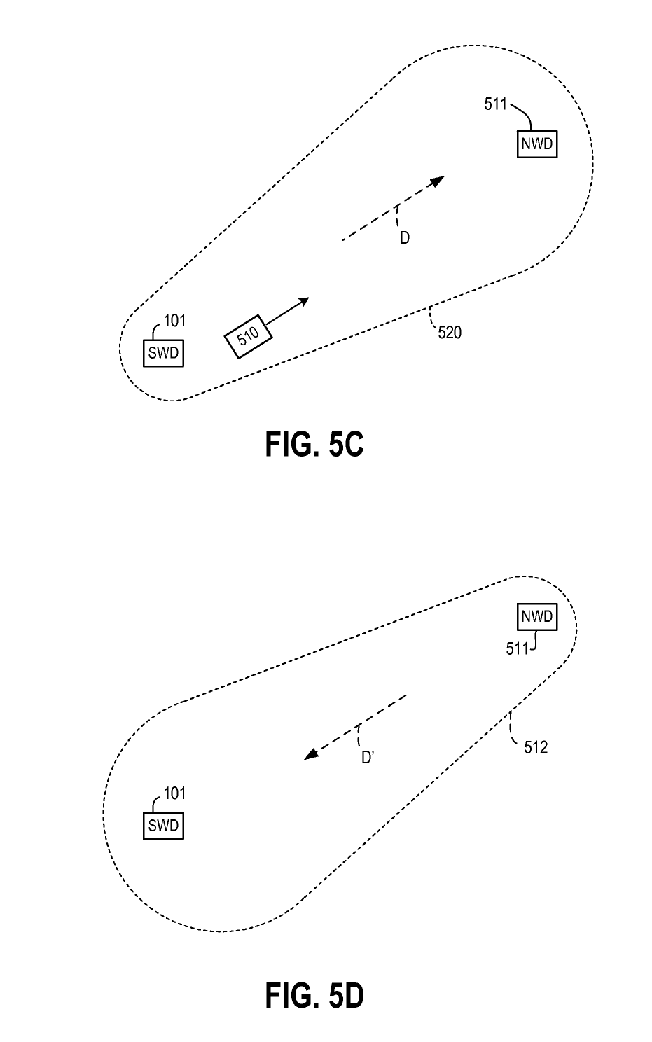

In some embodiments, SWD 101 may include data in active directional scan request communications that seeks a modification in the transmission and/or reception characteristics of an NWD. One example of such an embodiment is shown in FIGS. 5A and 5B. In FIG. 5A, SWD 101 is scanning directionally, in direction D, in an enhanced communication region 520. As part of that scanning, SWD 101 transmits a request communication 500. Communication 500 includes data that asks any responding NWD to increase its transmission power. In response, and as shown in FIG. 5B, NWD 501 increases its transmission power so as to increase its range from region 502 to region 503 and transmits a scan response communication (not shown). Region 503, only a portion of which is shown in FIG. 5B, includes the location of SWD 101. Subsequently, SWD 101 may select NWD 501 and establish a communication link with NWD 501. Because NWD 501 has increased its transmission power, SWD 101 may not need to remain in directional mode when communicating with NWD 501.

FIGS. 5C and 5D show another example of requesting an NWD to modify operating mode. In FIG. 5C, SWD 101 is again scanning directionally, in direction D, in an enhanced communication region 520. As part of that scanning, SWD 101 transmits a request communication 510. Communication 510 includes data that asks any responding NWD to increase its transmission in the direction SWD 101. This data may include information regarding the location of SWD 101 and/or regarding the direction in which SWD 101 is currently steering its transmissions. In response, and as shown in FIG. 5D, NWD 511 changes to directional mode on the channel over which communication 510 was received, steers its transmission in a direction D′ that is 180° is opposite to direction D, and transmits a scan response communication (not shown). As a result of the increase in transmission gain of NWD 511 in direction D′, the communication range of NWD 511 is changed to a region 512 that includes SWD 101. Subsequently, SWD 101 may select NWD 511 and establish a communication link. Because NWD 511 has increased its transmission gain, SWD 101 may not need to remain in directional mode when communicating with NWD 511.

In several of the embodiments described thus far, SWD 101 performs directional scanning after failing to identify a suitable candidate NWD through omnidirectional scanning. In some embodiments, however, SWD 101 may perform directional scanning without first attempting to identify an NWD through omnidirectional scanning. For example, SWD 101 may be configured to omit omnidirectional scanning if SWD 101 is in motion and to select scan directions as described in connection with FIGS. 3A and 3B. As another example, SWD 101 may be configured to perform directional scanning even after detecting a suitable candidate NWD through omnidirectional scanning (e.g., omit step 207 in FIG. 2A). After completing the directional scans, SWD 101 can then select (or receive a user selection of) an NWD from among NWDs detected during omnidirectional and directional scans. If the selected NWD was found through omnidirectional scanning, steps 208 could be performed. If the selected NWD was found through directional scanning, steps 227 could be performed.

In some embodiments, the results of one or more omnidirectional scans may be only one of several factors that affect whether directional scanning is performed. For example, SWD 101 may be configured so that it will only perform directional scanning if the results of the omnidirectional scan(s) meet certain requirements (e.g., no suitable NWDs were detected) and/or if a user has provided input indicating that directional scanning should be performed. As another example, SWD 101 may be configured so that it will only perform directional scanning if results of the omnidirectional scan(s) do not meet certain requirements (e.g., packet error rate exceeding a desired threshold) and/or an orientation sensor indicates that SWD 101 has a suitable orientation. As yet another example, SWD 101 may be configured so that it will only perform directional scanning if results of the omnidirectional scan(s) meet other specific requirements and/or battery strength is above a predefined level.

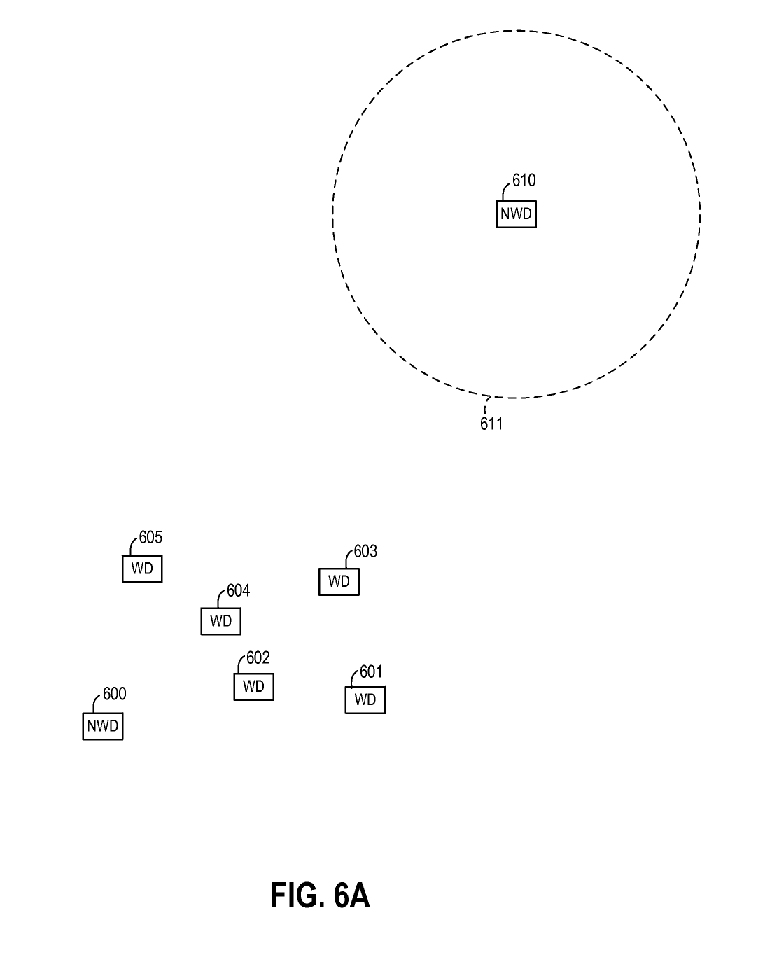

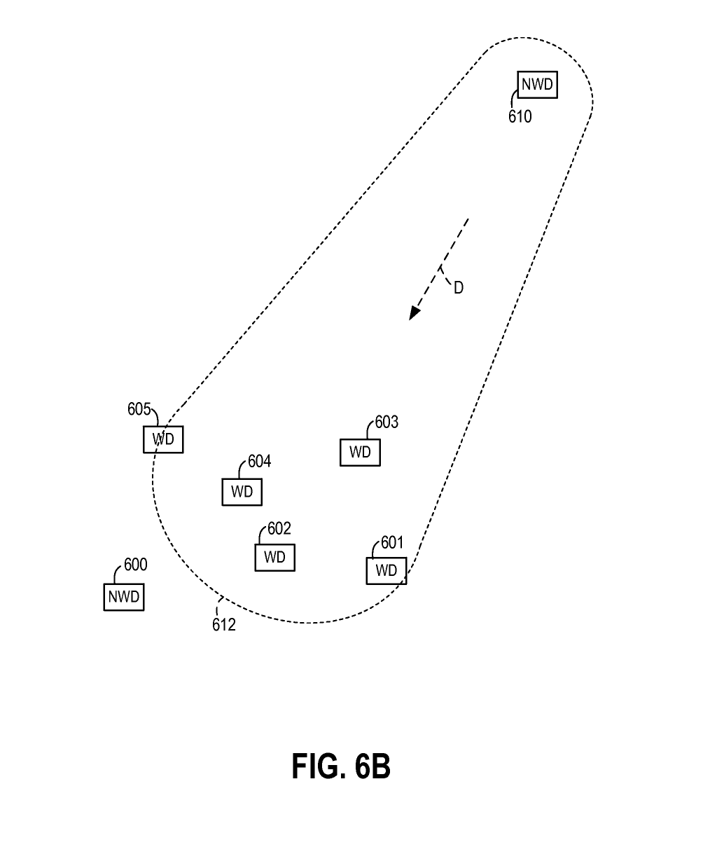

In some embodiments, an NWD may change to a directional mode without being asked to do so in a request communication from a SWD. For example, and as shown in FIG. 6A, multiple wireless devices (WD) 601-605 may be actively scanning or otherwise communicating with a first NWD 600. NWD 600 and wireless devices 601-605 may all be operating in omnidirectional mode. A second NWD 610 is operating in omnidirectional mode. Outside of a region 611, the transmission gain of NWD 610 is such that wireless devices 601-605 do not detect NWD 610 when those stations are in omnidirectional mode. Because of their proximity to NWD 600, wireless devices 601-605 are able to detect NWD 600 while in omnidirectional mode, and thus do not have occasion to detect NWD 610 using directional mode.

Although wireless devices 601-605 cannot detect communications from NWD 610 when NWD 610 is in omnidirectional mode, NWD 610 can detect communications from wireless devices 601-605. NWD 610 may, for example, have a larger antenna, have a low noise amplifier in the uplink direction or otherwise have enhanced reception sensitivity relative to wireless devices 601-605. NWD 610 can also determine the relative bearing of wireless devices 601-605 (e.g., using angle of arrival measurements as described above). Upon detecting communications from wireless devices 601-605, and as shown in FIG. 6B, NWD 610 changes to directional mode. In particular, NWD 610 configures its transceiver to increase transmission gain in a direction D generally corresponding to the center of the region in which wireless devices 601-605 are located. As a result, the transmission gain of NWD 610 within a region 612 is such that wireless devices 601-605 can now detect NWD 610 in an omnidirectional scan. NWD 610 might also increase its reception sensitivity in direction D.

Once NWD 610 increases its transmission gain as shown in FIG. 6B, one or more of wireless devices 601-605 may detect NWD 610. If such a station has not yet established a communication link with NWD 600, it might establish a communication link with NWD 610. Alternatively, one of wireless devices 601-605 that has established a link with NWD 600 might drop that link and establish a link with NWD 610 (e.g., because of congestion at NWD 600). In another embodiment, NWD 610 may be aware of a congestion situation at NWD 600 either implicitly by listening to a beacon broadcasted by NWD 600 which contains the BSS load element or explicitly through a distribution system when configured as an extended service set (ESS) in connection with NWD 600.

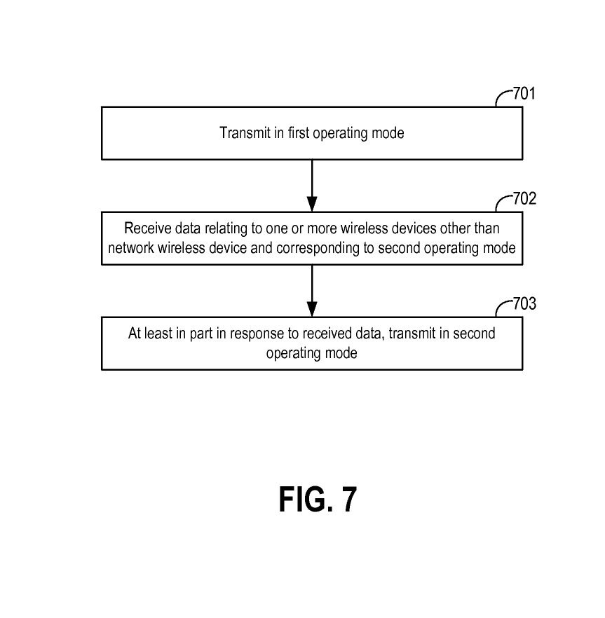

FIG. 7 is a block diagram showing operations performed by an NWD according to several embodiments. FIG. 7 merely represents certain embodiments. In other embodiments, one or more steps indicated in FIG. 7 may be omitted, rearranged or replaced with different steps. Other steps might also or alternatively be added. The steps indicated in FIG. 7 may be performed by a processor, an application specific integrated circuit (ASIC) and/or other hardware within an NWD. For convenience, performance of operations by such hardware will be generically described as performance of operations by the NWD. Such operations may be performed as the result of executing machine-executable instructions stored within one or more memories of the NWD and/or executing instructions that are stored as hard-coded dedicated logic.

In step 701, the NWD is transmitting in a first operating mode. The first mode may be an omnidirectional mode having a particular coverage region, e.g., a region outside of which transmissions from the NWD have an insufficient signal strength to allow those transmissions to be detected by one or more wireless devices with an acceptable error rate. In step 702, the NWD receives data that relates to one or more wireless devices other than the NWD and that corresponds to a second operating mode. The second operating mode has a coverage region that is different from the coverage region associated with the first operating mode. For example, the second operating mode could be an omnidirectional mode in which the NWD increases its transmission power so as to increase transmission gain in all directions. One example of such a second mode is described in connection with FIG. 5B. As another example, the second mode could be a directional mode in which the NWD steers it transmission in a specific direction such that the transmission gain in that direction is greater than transmission gain in other directions and/or greater than transmission gain in an omnidirectional mode at the same transmit power. In such a case, the second coverage region may extend further from the NWD than the first coverage region but be much narrower. Examples of such a second mode are described in connection with FIGS. 5D and 6B.

The data received in step 702 could come from several possible sources. As one example, the data could be contained in a scan request from a wireless device. Examples of this scenario are described in connection with FIGS. 5A and 5C. As another example, the data could be communicated, such as by either implicit or explicit means, other than scan requests directed to the NWD. An example of this scenario is described in connection with FIG. 6A.

In step 703, and at least in part in response to the data received in step 702, the NWD begins transmitting in the second operating mode.

Exemplary Hardware and/or Software

Various types of computers can be used to implement a wireless device such as an SWD or an NWD according to various embodiments. Exemplary computers include, without limitation, smart cards, media devices, personal computers, engineering workstations, PCs, Macintoshes, PDAs, portable computers, computerized watches, wired and wireless terminals, telephones, communication devices, servers, network access points, network multicast points, network devices, set-top boxes, personal video recorders (PVRs), game consoles, portable game devices, portable audio devices, portable media devices, portable video devices, televisions, digital cameras, digital camcorders, Global Positioning System (GPS) receivers and wireless personal servers.

A computer may execute one or more operating systems. Exemplary operating systems include Windows Phone (e.g., Windows Phone 7), Windows (e.g., Windows 8, Windows 7, or Windows Vista), Windows Server (e.g., Windows Server 8, Windows server 2008, or Windows Server 2003), Maemo, Meego, Android, Symbian OS, WebOS, Linux, OS X, and iOS. A computer may also support one or more of the S60 Platform, the .NET Framework, Java, and Cocoa. A computer may also include one or more processors operatively connected to one or more memory or storage units, wherein the memory or storage optionally contains machine-readable instructions and/or other data, and the processor or processors execute the machine-readable instructions and/or manipulate the data.

FIG. 8 shows an exemplary computer 800 according to some embodiments. Computer 800 includes a system bus 801 which operatively connects one or more processors 802, random access memory 803, read-only memory 804, input output (I/O) interfaces 805 and 806, storage interface 807, display interface 809 and global positioning system (GPS) chip 825. Storage interface 807 in turn connects to a mass storage 808. Each of I/O interfaces 805 and 806 may be one or more of an Ethernet, IEEE 1394, IEEE 1394b, IEEE 802.11-2012, IEEE 802.11a, 802.11af, IEEE 802.11b, IEEE 802.11g, IEEE 802.11i, IEEE 802.11e, IEEE 802.11n, IEEE 802.11ac, IEEE 802.11ad, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, IrDA (Infrared Data Association) or other type of interface. Interface 805 may include a transceiver 821, antennas 822 and 823, and other components for communication in the radio spectrum. Interface 806 and/or other interfaces (not shown) may similarly include a transceiver, one or more antennas, and other components for communication in the radio spectrum, and/or hardware and other components for communication over wired or other types of communication media. GPS chip 825 includes a receiver, an antenna 826 and hardware and/or software configured to calculate a position based on GPS satellite signals.

Mass storage 808 may be a hard drive, flash memory or other type of non-volatile storage device. Processor(s) 802 may be, e.g., an ARM-based processor such as a Qualcomm Snapdragon or an x86-based processor such as an Intel Atom or Intel Core. Computer 800 may also include a touch screen (not shown) and physical keyboard (also not shown). A mouse or keypad may alternately or additionally be employed. A physical keyboard might optionally be eliminated. Computer 800 may optionally include or be attached to one or more image capture devices.

Computer 800 may optionally include or be attached to one or more card readers, DVD drives, floppy disk drives, hard drives, memory cards, or ROM devices whereby media machine-readable instructions, including program code or other instructions for performing operations and communications described herein, is optionally inserted for the purpose of loading instructions onto the computer. Further, such machine-readable instructions may optionally be loaded onto the computer via one or more of I/O interfaces 805 and 806.

Computers may be configured to perform operations and communications described herein using one or more software modules. Such modules may be programmed using one or more languages. Exemplary languages include, without limitation, C#, C, C++, Objective C, Java, Perl, and Python.

Any indicated division of operations among particular software modules or devices is for purposes of illustration, and alternate divisions of operation are possible. Accordingly, any operations indicated to be performed by one software module are according to an alternative implementation instead performed by a plurality of software modules. Similarly, any operations indicated to be performed by a plurality of modules may according to an alternative implementation be performed by a single module.

Further, operations indicated to be performed by a particular computer such as an SWD or NWD may according to an alternative implementation instead performed by a plurality of computers such as by a plurality of SWDs and/or NWDs. Moreover, peer-to-peer, cloud, and/or grid computing techniques are optionally employed. Additionally, implementations may include remote communication among software modules. Exemplary remote communication techniques include Simple Object Access Protocol (SOAP), Java Messaging Service (JMS), Remote Method Invocation (RMI), Remote Procedure Call (RPC), sockets, and pipes.

Operations discussed herein may be implemented via hardware that contains hard-coded instructions (e.g., logic gates and other structures) configured to perform operations and communications described herein. Examples of such implementation via hardware include the use of one or more of integrated circuits, specialized hardware, chips, chipsets, application-specific integrated circuits (ASICs), and field-programmable gate arrays (FPGAs). Machine-executable instructions can include hard-coded instructions.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that operations and communications illustrated in the illustrative figures may be performed in other than the recited order, and that one or more illustrated operations and communications may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention, including all permutations of the independent and dependent claims set forth herein.

1. A method comprising:
performing, by a scanning wireless device, one or more omnidirectional scans for network wireless devices;
determining, by the scanning wireless device and based at least in part on results of the one or more omnidirectional scans, to perform one or more directional scans for network wireless devices;
selecting, by the scanning wireless device, one or more scan directions; and
performing, by the scanning wireless device, a directional scan for network wireless devices in at least one of the one or more selected scan directions.

2. The method of claim 1, wherein the directional scan comprises at least one of
increasing a receiving sensitivity of the scanning wireless device in the selected scan direction relative to a receiving sensitivity of the scanning wireless device in other directions and relative to a receiving sensitivity of the scanning wireless device during the one or more omnidirectional scans, and
increasing a transmission gain of the scanning wireless device in the selected scan direction relative to a transmission gain of the scanning wireless device in other directions and relative to a transmission gain of the scanning wireless device during the one or more omnidirectional scans.

3. The method of claim 1, wherein selecting one or more scan directions comprises accessing a stored scan direction list.

4. The method of claim 1, wherein selecting one or more scan directions comprises
determining the scanning wireless device is in motion,
determining one or more directions corresponding to a direction of the scanning wireless device motion, and
selecting the one of more determined directions.

5. The method of claim 1, further comprising:
identifying network wireless devices in response to at least a portion of the one or more directional scans;
generating images on a display indicating the identified network wireless devices; and
receiving a user selection of one of the identified network wireless devices.

6. The method of claim 1, wherein the directional scan is an active scan and comprises transmitting data indicating a request for a network wireless device to modify a coverage region.

7. The method of claim 6, wherein data indicating a request for a network wireless device to modify its coverage region comprises data indicating a direction of the scanning wireless device relative to the network wireless device.

8. The method of claim 1, wherein
performing one or more omnidirectional scans comprises detecting a network wireless device and determining a direction of the network wireless device relative to the scanning wireless device, and
selecting one or more scan directions comprises excluding the determined direction.

9. An apparatus comprising:
at least one processor; and
at least one memory, at least one of the at least one memory and at least one processor storing machine-executable instructions that cause the apparatus, upon execution of the instructions, to at least
perform one or more omnidirectional scans for network wireless devices,
determine, based at least in part on results of the one or more omnidirectional scans, to perform one or more directional scans for network wireless devices,
select one or more scan directions, and
perform a directional scan for network wireless devices in at least one of the one or more selected scan directions.

10. The apparatus of claim 9, wherein the directional scan comprises at least one of
increasing a receiving sensitivity of the apparatus in the selected scan direction relative to a receiving sensitivity of the apparatus in other directions and relative to a receiving sensitivity of the apparatus during the one or more omnidirectional scans, and
increasing a transmission gain of the apparatus in the selected scan direction relative to a transmission gain of the apparatus in other directions and relative to a transmission gain of the apparatus during the one or more omnidirectional scans.

11. The apparatus of claim 9, wherein selecting one or more scan directions comprises accessing a stored scan direction list.

12. The apparatus of claim 9, wherein selecting one or more scan directions comprises
determining the apparatus is in motion,
determining one or more directions corresponding to a direction of the apparatus motion, and
selecting the one of more determined directions.

13. The apparatus of claim 9, wherein the machine-executable instructions cause the apparatus, upon execution of the instructions, to at least
identify network wireless devices in response to at least a portion of the one or more directional scans,
generate images on a display indicating the identified network wireless devices, and
receive a user selection of one of the identified network wireless devices.

14. The apparatus of claim 9, wherein the directional scan is an active scan and comprises transmitting data indicating a request for a network wireless device to modify a coverage region.

15. The apparatus of claim 14, wherein data indicating a request for a network wireless device to modify its coverage region comprises data indicating a direction of the apparatus relative to the network wireless device.

16. The apparatus of claim 9, wherein
performing one or more omnidirectional scans comprises detecting a network wireless device and determining a direction of the network wireless device relative to the apparatus, and
selecting one or more scan directions comprises excluding the determined direction.

17. One or more non-transitory machine-readable media storing machine-executable instructions that, when executed by a device, cause the device to at least:
perform one or more omnidirectional scans for network wireless devices;
determine, based at least in part on results of the one or more omnidirectional scans, to perform one or more directional scans for network wireless devices;
select one or more scan directions; and
perform a directional scan for network wireless devices in at least one of the one or more selected scan directions.

18. A method comprising:
transmitting from a network wireless device in a first mode, the first mode transmissions having a first coverage region;
receiving data relating to one or more wireless devices other than the network wireless device and corresponding to a second mode in which transmissions will have a second coverage region different from the first coverage region; and
at least in part in response to the received data, transmitting from the network wireless device in the second mode.

19. An apparatus comprising:
at least one processor; and
at least one memory, at least one of the at least one memory and at least one processor storing machine-executable instructions that cause the apparatus, upon execution of the instructions, to at least
transmit in a first mode, the first mode transmissions having a first coverage region,
receive data relating to one or more wireless devices other than the apparatus and corresponding to a second mode in which transmissions will have a second coverage region different from the first coverage region, and
at least in part in response to the received data, transmit in the second mode

20. The apparatus of claim 19, wherein receiving data comprises receiving a request from a wireless device to modify a coverage region.

21. The apparatus of claim 20, wherein the request from the wireless device comprises a request to modify a coverage region and a direction associated with the wireless device.

22. The apparatus of claim 19, wherein the first mode comprises omnidirectional transmissions and the second mode comprises directional transmissions.
